(19) United States
(12) Patent Application Publication
(10) Pub. No.: US 2008/0115406 A1
(43) Pub. Date: May 22, 2008

(54) INSECT CONTROL TAPE

(76) Inventors: Tyler D. Duston, Evanston, IL (US); Steven B. Mineau, Racine, WI (US); Jose de Jesus Castillo Higareda, Racine, WI (US); John H. Hainze, Milwaukee, WI (US); Nancy J. Vnuk, South Milwaukee, WI (US)

Correspondence Address: S.C. JOHNSON & SON, INC., 1525 HOWE STREET, RACINE, WI, 53403-2236, US

(21) Appl. No.: 11/560,386

(22) Filed: Nov. 16, 2006

(51) Int. Cl. A01M 1/20

(52) U.S. Cl. 43/131; 43/114; 43/132.1

(57) ABSTRACT

An insect control tape that includes a substrate having a longitudinal direction with a first face and a second face opposite the first face. An insecticide or other pest control agent is applied to the first face in a longitudinal strip with adjacent side regions that are free of the agent. An adhesive covers at least part of the second face to anchor the tape on a floor. A web covers the first face and the agent. A consumer can press the tape down on a floor by contacting the web to install the tape, with reduced risk of contacting active, while still permitting crawling insects such as roaches to normally contact the active as they crawl over the tape.

### CROSS-REFERENCE TO RELATED APPLICATIONS

Not applicable.

### STATEMENT REGARDING FEDERALLY SPONSORED RESEARCH/DEVELOPMENT

Not applicable.

### BACKGROUND OF THE INVENTION

The present invention relates to devices for controlling crawling insects and other crawling pests commonly controlled along with them. More particularly it relates to insect control tapes.

Crawling insects can be an annoyance in addition to being a hygienic risk. They also may damage the structure or contents of a building. In any event, they are aesthetically unpleasant when noticed inside a building.

A wide variety of insecticides and other insect control agents are known that can control common types of crawling insects on contact. The most frequently used technique for delivering such contact insecticides to surfaces for the control of crawling insects is by use of an aerosol or other spray. However, it can be difficult to specifically control exactly where a spray lands on a surface to be treated. Furthermore, any insecticide merely applied directly to a surface is subject to being unintentionally removed by incidental touching or other contact.

Conventional pest control strips have the advantage of allowing precise application of insecticide to a surface. However, they have certain disadvantages.

For example, U.S. Pat. No. 1,161,537 discloses a pest control strip that can either be a single strip or segmented patches defined by tear lines. A poisonous paste is positioned only at periodic locations along the strip. The paste remains fully exposed and thus can be contacted accidentally by a person handling the strip or moving near it.

U.S. Pat. No. 2,808,679 discloses that an adhesive may be used to create an insecticidal tape that can be anchored at a desired position. However, when a guard strip is removed to expose an insecticide after the tape is first installed, the insecticide is thereafter fully exposed, allowing unintended human contact.

U.S. Pat. No. 2,315,772 describes the use of an adhesive strip to keep a tape in place. However, again, the active is susceptible to unintended contact.

U.S. Pat. No. 5,353,542 discloses the use of a mesh layer above an adhesive trapping layer, in a flea trap. This is a fairly complex trap device unrelated to surface application of a material, and in any event does not involve insecticidal control.

U.S. Pat. No. 6,360,477 discloses a pouch of volatile material that includes the use of end regions left free of insect control material to facilitate the opening of the pouch. This device is for flying insect control, and in any event does not contemplate adhesive attachment to a surface.

Other examples of insect control devices include U.S. Pat. Nos. 4,829,702, 4,862,638, 4,908,977 and 6,360, 477.

Notwithstanding these prior developments, there is a need for improved insect control strips, particularly ones that restrict inadvertent contact with the active ingredients during and after installation.

### BRIEF SUMMARY OF THE INVENTION

The present invention relates to insect control tapes that are effective against crawling insects, and that also protect a user, or other person or pet, from unintended contact with the active, particularly during installation. The term “insect”, as used herein, is meant to include actual insects as well as other small arthropod pests commonly controlled with agents that are also effective against insects.

In one aspect of the present invention there is provided an insect control tape. It has a substrate having a longitudinal direction, with a first face and a second face opposite said first face. A pest control agent is applied to part of the first face (e.g. a central strip), but not to another part of the first face. There is also a web positioned over the first face and the agent, the web having openings extending through the web, exposing portions of the first face to which pest control agent has been applied.

There may also be an adhesive that covers at least part of the second face, and a removable lower sheet covering the adhesive. This provides an effective means of anchoring the tape at a particular location.

In other preferred forms there is a cover strip around a perimeter of the tape, the cover strip covering edges of at least the substrate and the web, and the agent is a contact type insecticide applied along a central strip of the first face extending in the longitudinal direction, but not along at least one lateral longitudinally extending region of the first face. For example, the agent could comprise permethrin applied along the center of the substrate on its top surface.

Depending on the active that is selected, the tape can be capable of controlling crawling insects, including, but not limited to, cockroaches, ants, earwigs, spiders, sow bugs and similar crawling pests, by the insect crawling over the tape and contacting the agent as it does so. To help maximize the likelihood of traversing insects contacting the agent as they crawl over the tape, it is preferred that the tape have a side-to-side width of at least 2.5 cm. Too much width renders the tape expensive to produce and use, and aesthetically undesirable. Too little lowers the probability of the insect contacting the active. Hence, it is preferred that the tape have an average width of between 5 and 10 cm, most preferably about 7.62 cm.

If the web openings are too small in area a crawling insect may nevertheless simply safely walk across the web by walking on the web structure only without contacting the active agent. On the other hand, if the openings are too large there is an increased risk that the web will not effectively prevent human contact with the agent. Hence, it is preferred that the web have an average top view opening area of between about 0.1 cm sq. and 0.5 cm sq, such as between 0.1080 cm sq (0.0156 in sq) and 0.4032 cm sq (0.0625 in sq), such as an area of 0.1764 cm sq (0.027 in sq). The web can conveniently be in the form of a generally rectangular grid.

In another aspect the invention provides a method of installing an insect control tape on a supporting surface. One obtains an insect control tape having a substrate with a longitudinal direction, further with a first face and a second face opposite said first face. The tape also has a pest control agent applied to part of the first face, but not to another part of the first face, an adhesive covering at least part of the second face, and a web over the first face and the agent. One then runs a finger along the web over said another part in the longitudinal direction. As a result a portion of the adhesive is pressed against the supporting surface without the finger contacting the agent.

Such tapes can be used to ring a location to be protected, such as a floor drain or trash container, or be used as an elongated fencing strip across a window sill, a storage cabinet opening or wall, or the like. Preferably, the positioning is such that crawling insects must crawl over the tape to enter the protected area through the controlled entry. When they do, the web openings should be large enough to allow the insects to readily contact the active as they traverse the tape.

In the most preferred form of the tape, there is a lateral region along at least one side of the tape that is free of active. The web over that region of the tape can be pressed with a finger to install the tape with an even further reduced likelihood of contacting the active.

Moreover, there can be indicia on the tape, or instructions accompanying the tape, directing the consumer to contact only this lateral area. That further reduces the risk of contacting active as the tape is installed.

Tapes of the present invention are inexpensive to produce, easy to install, and with appropriate selection of active for the insect to be controlled, and appropriate placement, effective for a wide variety of applications and insects.

The foregoing and other advantages of the present invention will become apparent from the following description. In that description reference is made to the accompanying drawings which form a part thereof, and in which there is shown by way of non-limiting illustration a preferred embodiment of the invention.

### BRIEF DESCRIPTION OF THE DRAWINGS

FIG. 1 is a perspective view of an embodiment of an insect control tape according to the present invention, shown with a lower protective release layer partially peeled away;

FIG. 2 is an exploded perspective view of the tape of FIG. 1; and

FIG. 3 is cross-sectional view of the tape of FIG. 1, taken along section line 3-3 of FIG. 1.

### DETAILED DESCRIPTION OF THE PREFERRED EMBODIMENTS

Insect control tape 10 includes a substrate 12 in the form of a strip-like film that has a longitudinal direction 14, a first face 16, and a second face 18 opposite first face 16. An insect control agent (e.g. preferably an insecticide, insect repellent or insect growth regulator) 20 is applied to a central strip 26 of first face 16 and extends continuously in longitudinal direction 14. Adhesive 22 covers at least part of second face 18. A web 24 covers at least the central strip 26 and preferably the entire first face 16 and agent 20.

Insect control tape 10 is preferably about 7.62 cm wide and of a length in the longitudinal direction which is selected based on the application. While the strip shown is a linear strip, it could instead be in arc form, particularly if the strip is intended as a surrounding barrier around a drain or the like.

The central strip 26 could be about four centimeters wide. However, such dimensions are merely exemplary and other shapes and dimensions are within the scope of the present invention.

Where roach control is desired, agent 20 preferably includes by weight between 60% and 85% (permethrin), between approximately 15% and 35% piperonyl butoxide, and between approximately 1% and 5% of a denatonium benzoate/ethyl alcohol solution (a bittering agent to deter a pet from chewing on the tape). An effective control has been achieved using this formulation at a coating of about 2.2 milligrams of permethrin per square inch. For roaches other insect control agents include, but are not limited to natural pyrethrins, as well as synthetic insecticides such as permethrin, bifenthrin, cypermethrin, cyfluthrin, and deltamethrin (all of which can be used with piperonyl butoxide as a synergist).

For ants preferred insect control agents include, but are not limited to permethrin, bifenthrin, cypermethrin, cyfluthrin, natural pyrethrins (all of which can be used with piperonyl butoxide as a synergist), and 100% boric acid.

For other insects the active will be chosen for efficacy against the pest of interest, as is well known in the art.

Agent 20 can be deposited as a thin film on substrate 12, or alternatively can be impregnated into substrate 12 provided that the impregnation technique leaves the upper surface of the substrate with available active to be contacted. For example, the combination of the substrate and the agent 20 can preferably include by weight between 90% and 99% polypropylene film, with the rest remaining being the formulation containing the agent 20. While plastics are the preferred substrate 12, particularly clear film plastics, a wide variety of other substrates could be used (e.g. cellulosic substrates).

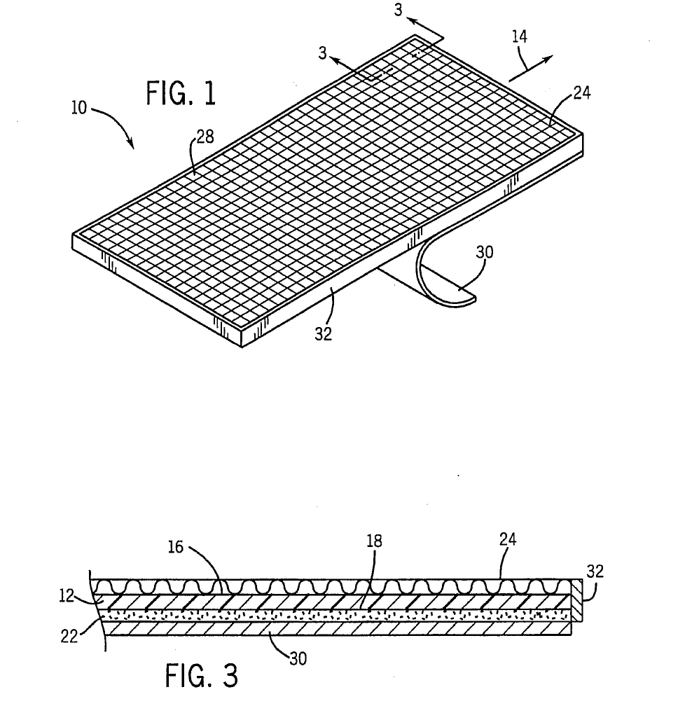

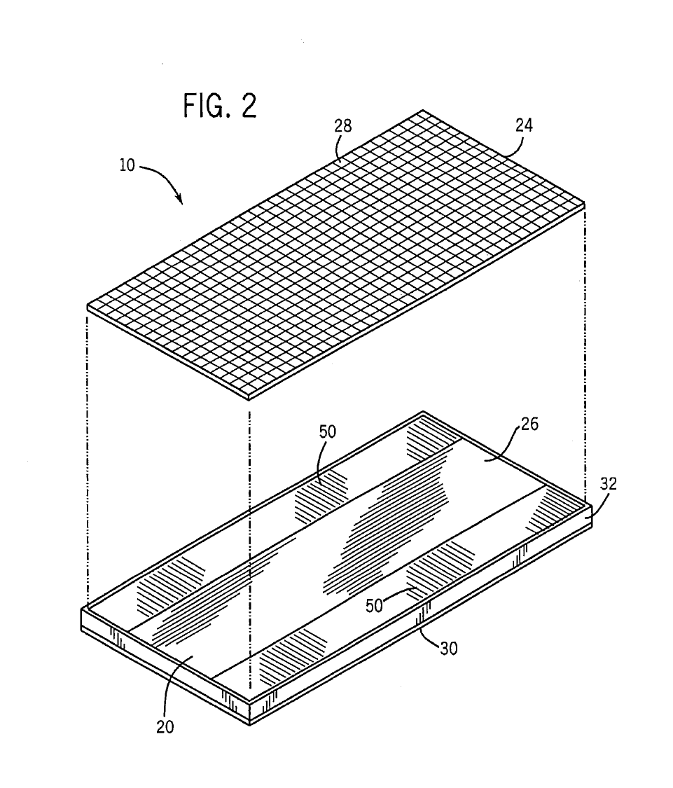

Web 24 preferably includes an array of vertically extending through openings 28 of approximately 0.8 centimeters across. While the openings in the web 24 are depicted in FIG. 1 as essentially rectangular and formed as part of a mesh structure, the openings could instead have other shapes (e.g. circular or irregular), and could be cut into or formed integrally in a slab or other similar structure.

Adhesive 22 should be an adhesive that will easily release layer 30, firmly anchor the tape to a painted or wood surface or to conventional flooring, and yet at some point permit removal of the tape without damaging the surface or flooring. It is preferred to use a conventional low tack or, at most, a medium tack adhesive such as those well known to those skilled in the art and available from such companies as the 3M Company of Minneapolis, Minn.

Web 24 can be formed of polypropylene or other synthetic or natural substrates. A cover strip 32 around a perimeter of insect control tape 10 can further isolate the treated portion of the substrate 12 from contact by a human. Of course, the use of such a strip is not as important if the agent is only centrally applied to the strip.

Release layer 30 is preferably a silicone coated release paper. Cover strip 32, if used, can be made of polypropylene and be affixed to the tape by heat sealing or other conventional means.

While this invention has been described as having specific features with reference to the preferred embodiment, the present invention can be further modified within the spirit and scope of this disclosure. For example, the tape can be a strip with preformed tear lines to facilitate dividing the strip into a number of shorter pieces. Further, the adhesive need not be applied directly to the bottom of the substrate 12 as a coating. Rather, a double sided adhesive tape could be used contacting the substrate on one side and a support surface (or peel-off layer) on the other.

Also, the adhesive need not be present at the time of sale of the tape. Rather, a consumer could squirt a line of adhesive onto a floor or the like, and then put the substrate tape thereon. Hence, the claims, not just the preferred embodiments, should be looked to in order to judge the full scope of the invention.

### INDUSTRIAL APPLICABILITY

The present invention provides insect control tapes that can be installed and used with reduced risk of human contact with insect control agents.

1. An insect control tape suitable for controlling a crawling insect if the tape is positioned on a floor surface, the tape comprising:
a substrate having a longitudinal direction with a first face and a second face opposite said first face;
a pest control agent applied to a first part of said first face, but not to another part of said first face; and
a web positioned over said first face and said agent, over both the first part and said another part, the web having holes therethrough.

2. The tape of claim 1, further comprising an adhesive covering at least part of said second face.

3. The tape of claim 2, further comprising a removable lower sheet covering the adhesive.

4. The tape of claim 1, further comprising a cover strip around a perimeter of the tape, said cover strip covering edges of at least said substrate and said web.

5. The tape of claim 1, wherein said agent is applied along a central strip of said first face extending in said longitudinal direction, but not along at least one lateral longitudinally extending region of the first face.

6. The tape of claim 1, wherein the agent comprises an insecticide.

7. The tape of claim 6, wherein the agent comprises permethrin.

8. The tape of claim 1, wherein the tape is capable of controlling an insect selected from the group consisting of cockroaches, ants, earwigs, spiders and sow bugs if the insect crawls over the tape and contacts the agent.

9. The tape of claim 1, wherein the tape has an average width of between 5 and 10 cm.

10. The tape of claim 1, wherein the web has an average top view opening area of between 0.1 cm sq. and 0.5 cm sq.

11. The tape of claim 1, wherein the web is in a form of an essentially rectangular grid.

12. A method of installing an insect control tape that is suitable to control a crawling insect on a supporting floor surface, comprising the steps of:
obtaining an insect control tape, comprising:
a substrate having a longitudinal direction with a first face and a second face opposite said first face;
a pest control agent applied to a first part of said first face, but not to another part of said first face;
an adhesive covering at least part of said second face; and
a web over both said first part and said another part of said first face and said agent; and
running a finger along the web over said another part in the longitudinal direction;
whereby a portion of the adhesive is pressed against the supporting surface without the finger contacting the agent
